(19) United States
(12) Patent Application Publication
(10) Pub. No.: US 2013/0296091 A1
(43) Pub. Date: Nov. 7, 2013

(54) VARIABLE SPEED DRIVE FOR AIRCARFT APPLICATIONS

(71) Applicants: Glenn C. Lemmers, JR., Loves Park, IL (US); Brandon M. Grell, Cherry Valley, IL (US); Todd A. Spierling, Byron, IL (US); David S. Behling, Belvidere, IL (US)

(72) Inventors: Glenn C. Lemmers, JR., Loves Park, IL (US); Brandon M. Grell, Cherry Valley, IL (US); Todd A. Spierling, Byron, IL (US); David S. Behling, Belvidere, IL (US)

(73) Assignee: HAMILTON SUNDSTRAND CORPORATION, Windsor Locks, CT (US)

(21) Appl. No.: 13/462,197

(22) Filed: May 2, 2012

(51) Int. Cl. F16H 48/32; F16H 48/34; F16H 37/08

(52) U.S. Cl. 475/84; 475/199; 475/150

(57) ABSTRACT

A variable speed drive (AVSD) includes an input shaft connected to receive a mechanical input from an aircraft engine and an output shaft connected to provide a speed-controlled mechanical output. The AVSD includes a first power path having a fixed gear ratio, a second power path having a variable gear ratio, and a differential coupled to combine power received from the first power path and the second power path for provision to the output shaft. A controller modifies the variable gear ratio of the second power path to regulate the output shaft of the AVSD to a desired speed.

### BACKGROUND

The present invention is related to a variable speed drive, and in particular to a variable speed drive employed in aircraft applications.

Aircraft applications present a variety of unique considerations regarding power distribution and efficiency. Unlike ground-based applications, all power consumed on an aircraft, whether electrical, mechanical, hydraulic, or pneumatic, is derived from power generated by the aircraft engines themselves.

The overall efficiency of the aircraft engines (i.e., amount of fuel consumed) depends on how efficiently the systems on the aircraft utilize the generated power. For example, a number of traditional aircraft systems utilize pneumatic power in the form of bleed air. However, bleed air represents energy loss from the engine, and its use therefore decreases the overall efficiency of the aircraft system. An alternative to pneumatic power derived from bleed air is electric power derived from generators mechanically coupled to the engines. Mechanical power generated by the aircraft engines is converted to electric power by the generators, distributed to a desired load, and converted back to mechanical energy via an electric motor. Traditionally, pneumatic and/or electric power is used to power aircraft systems such as compressors employed in conjunction with environmental control systems (ECS) because of the need to drive the compressors at variable speeds. However, utilizing electric energy requires converting mechanical energy (generated by the rotating aircraft engine) to electric energy for distribution to the motors, and subsequent conversion back to mechanical energy for consumption by the load (i.e., compressor, pump, etc.). The added weight of those components similarly decreases the efficiency of the aircraft engine.

### SUMMARY

An advanced variable speed drive (AVSD) includes an input shaft connected to receive a mechanical input from an aircraft engine and an output shaft connected to provide a speed-controlled mechanical output. The AVSD includes a first power path having a fixed gear ratio, a second power path having a variable gear ratio, and a differential coupled to combine power received from the first power path and the second power path for provision to the output shaft. A controller modifies the variable gear ratio of the second power path to regulate the output shaft of the AVSD to a desired speed.

### BRIEF DESCRIPTION OF THE DRAWINGS

FIG. 1 is a block diagram of an aircraft system that employs an advanced variable speed drive (AVSD) to provide a variable speed output according to an embodiment of the present invention.

FIG. 2 is mathematical representation of mechanical and hydraulic gear ratios employed within the AVSD to provide a variable speed output according to an embodiment of the present invention.

FIG. 3 is a cross-sectional view of the AVSD according to an embodiment of the present invention.

### DETAILED DESCRIPTION

The present invention employs an advanced variable speed drive (AVSD) to convert a variable speed mechanical input received from the engine to a controlled, variable speed output. A benefit of the present invention is it allows a variable speed mechanical input to be converted to a controlled, variable speed output without requiring conversion of mechanical engine power to either pneumatic power or electrical power.

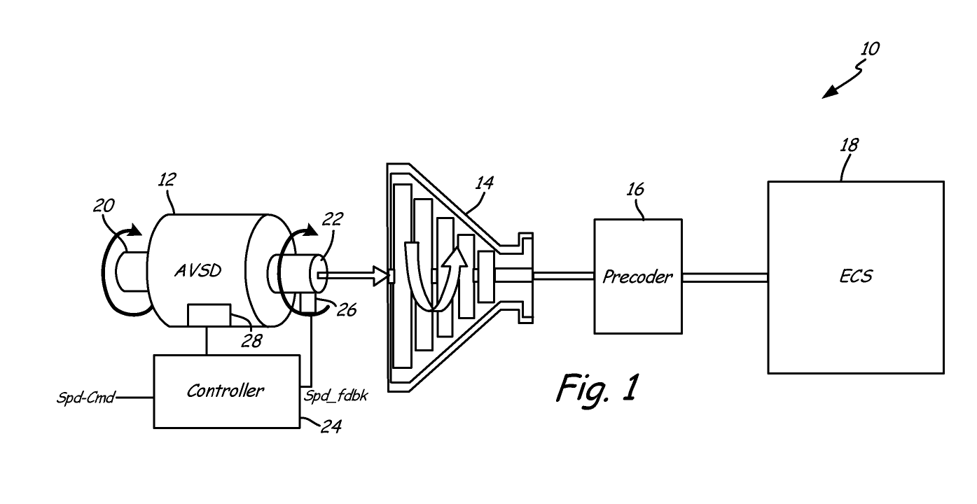

FIG. 1 is a block diagram of aircraft system 10 according to an embodiment of the present invention. Aircraft system 10 includes advanced variable speed drive (AVSD) 12, cabin air compressor (CAC) 14, pre-cooler 16, and environmental control system ECS 18. Input shaft 20 communicates mechanical power from the aircraft engine (not shown) to AVSD 12, which converts the variable speed mechanical input to a desired variable speed mechanical output provided via output shaft 22 to CAC 14.

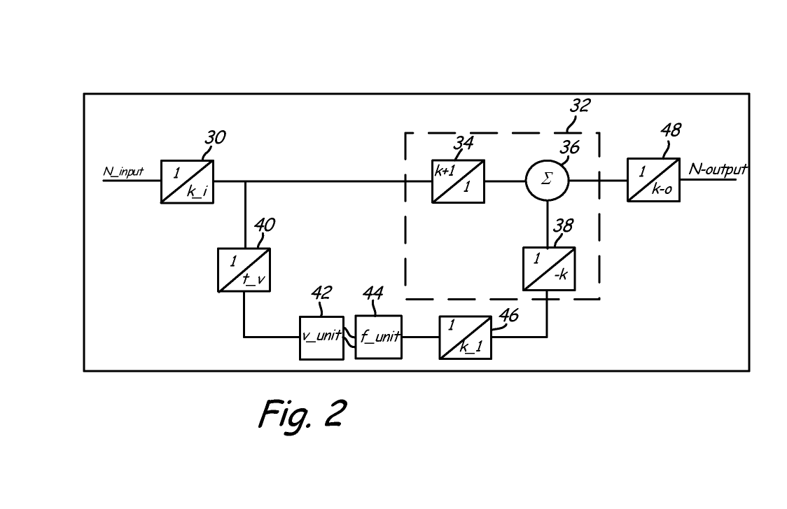

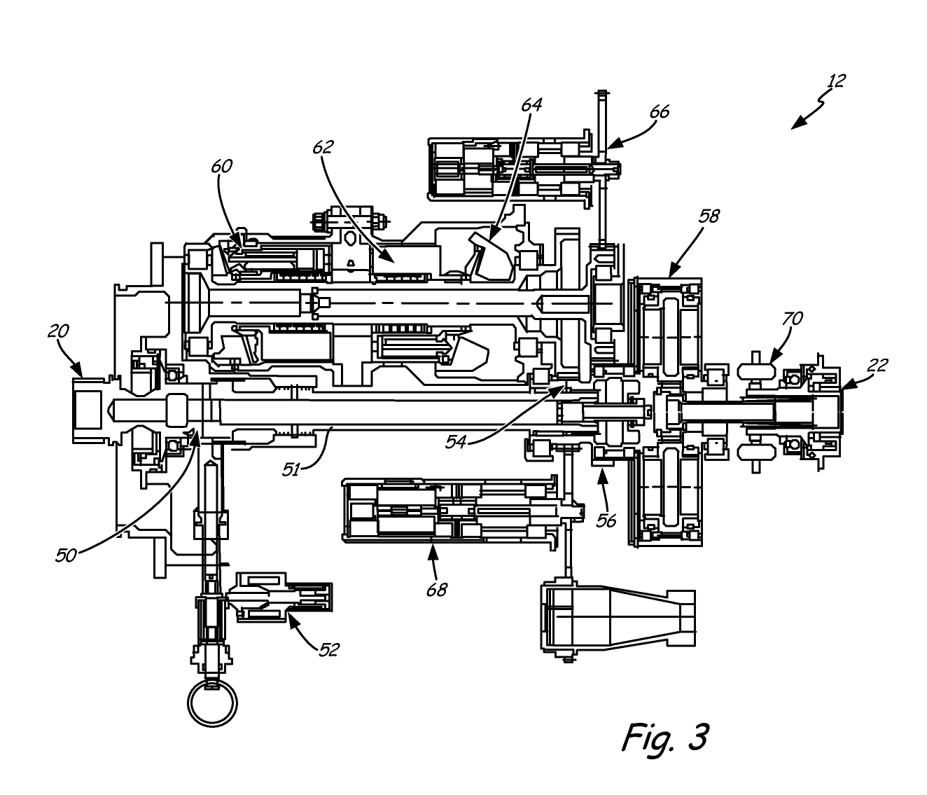

Controller 24 receives a speed command spd_cmd that represents the desired speed of output shaft 22. The speed command may be provided by CAC 14, ECS 18 or some other aircraft control system based on operating conditions of the aircraft. Controller 24 also receives a speed feedback signal spd_fdbk from speed sensor 26 that represents the speed of output shaft 22. In response to differences between the speed command signal spd_cmd and the speed feedback signal spd_fdbk, controller 24 provides a control signal to actuator 28 included within AVSD 12 to selectively regulate, in closed loop fashion, the speed of output shaft 22. As described in more detail with respect to FIGS. 2 and 3, AVSD 12 is a hydro-mechanical device that includes a first, fixed gear ratio power path, a second, variable gear ratio power path, and a differential for summing the outputs of each power path. The control signal provided by controller 24 to actuator 28 varies the gear ratio of the second power path, thereby adding or subtracting speed from the first power path to provide a desired output speed.

In the embodiment shown in FIG. 1, AVSD 12 is mechanically coupled to CAC 14 via output shaft 22. Mechanical power provided via output shaft 22 rotates the plurality of compressor blades associated with CAC 14 to compress ambient air. The speed at which CAC 14 is driven determines the flow rate of compressed air provided to pre-cooler 16, and is varied depending on the application and circumstances (e.g., varied depending on flight conditions). Pre-cooler 16 acts to remove thermal energy from the compressed air provided by CAC 14, and provides cooled, compressed air to ECS 18 for mixing and/or distribution to the aircraft cabin.

FIG. 2 is mathematical representation of mechanical and hydraulic gear ratios employed within the AVSD to provide a variable speed output according to an embodiment of the present invention. The input N_input represents the speed of input shaft 20. The output N_output represents the speed of output shaft 22 provided to CAC 14 (shown in FIG. 1), and as illustrated in the mathematical model is based on the input speed N_input. In this model, gear ratios are represented as boxes that operate on the input speed to generate the desired output speed. For example, in the embodiment shown in FIG. 2, the input speed N_input is applied to gear ratio box 30, which includes a gearing ratio of 1/k_i, such that the output of gear ratio box 30 in relation to the input is represented as N_input*1/k_i. In the embodiment shown in FIG. 3, the variable k_i is assigned a value of one, such that the output of gear ratio box 30 is equal to the output of gear ratio box 30 (e.g., 1:1 ratio). In other embodiments, the value of k_i may be varied depending on the application. For example, in the embodiment shown in FIG. 2, the input N_input varies between 6,847 revolutions per minute (rpm) and 13,545 rpms, with an output controllable over the range of 41,874 rpms-50,821 rpms.

The output of gear ratio box 30 is split into first and second power paths (i.e., split power path). The first power path includes mechanical gear elements comprising fixed gear ratios. The second power path includes a combination of mechanical and hydraulic gear elements capable of providing variable gear ratios that allow speed to be selectively increased or decreased as desired. Differential 32 is a mechanical device for summing the power provided by the first power path with the power provided by the second power path (i.e., summing the speed of the output provided by the first power path with the speed of the output of the second power path). An exemplary embodiment of differential 32 is illustrated in FIG. 3, in which an epicyclic differential employing a ring gear, planetary gear and sun gear is employed to sum the power provided by the respective first and second power paths. In essence, differential 32 adds or subtracts the speed of the second power path to the speed of the first power path to provide a desired output speed N_output.

The mathematical representation of differential 32 includes second gear ratio box 34 and third gear ratio box 38. Second gear ratio box is represented as (k+1)/1, with the value of k selected based on the application to provide the desired output. Similarly, third gear ratio is represented as 1/−k, with the value of k selected based on the application to provide the desired output. Sum box 36 illustrates mathematically the combination of power/speed provided by the first power path with the power/speed provided by the second power path.

The second power path includes mechanical and hydraulic components, including fourth gear ratio 40, variable displacement unit 42, fixed displacement unit 44, and fifth gear ratio box 46. Fourth gear ratio box 42 mechanically couples the output of gear ratio box 30 with variable displacement unit 42, and applies a gear ratio of 1/k_v. Variable displacement unit 42 converts the received mechanical input to a variable flow of hydraulic power that is communicated to fixed displacement unit 44 (as indicated by the wavy lines connecting variable displacement unit 42 and fixed displacement unit 44). Controller 24 (shown in FIG. 1) selectively varies the volume per revolution of hydraulic fluid pumped by variable displacement unit 42 and communicated to fixed displacement unit 44. Fixed displacement unit 44 converts the flow of hydraulic fluid to a mechanical output that is communicated to differential 32 via fifth gear ratio box 46, which applies a gear ratio of 1/k_f. In this way, the gear ratio and therefore the speed of the mechanical output provided by the second power path to differential 32 can be varied by selectively controlling the operation of variable displacement unit 42.

As discussed above, differential 32 adds (or subtracts) the power provided by the second power path to the power received from the first power path. The output is applied to sixth gear ratio box 48, represented in this embodiment as 1/k_o, the output of which represents the output speed N_output of output shaft 22. In this embodiment, the value of the variable k_o is set equal to one, although in other embodiments the value of k_o is selected based on the application requirements.

FIG. 3 is a cross-sectional view of advanced variable speed drive (AVSD) 12 according to an embodiment of the present invention, which receives a mechanical input via input shaft 20 and provides a regulated, variable speed output via output shaft 22. In the embodiment shown in FIG. 3, AVSD 12 includes face clutch disconnect 50, carrier shaft 51, thermal/electrical disconnect solenoid 52, gears 54 and 56, epicyclic differential 58, fixed displacement unit 60, variable displacement unit 62, swash plate 64, accessory pumps 66 and 68, and speed sensor 70.

Face clutch disconnect 50 is connected between input shaft 20 and carrier shaft 51, and acts to both mechanically couple input shaft 20 to carrier shaft 51 and to disconnect input shaft 20 from carrier shaft 51 in response to fault conditions to protect internal components of AVSD 12. In the embodiment shown in FIG. 3, thermal/electric disconnect solenoid 52 is the mechanism for disengaging face clutch 50 in the event of a fault.

Carrier shaft 51 communicates mechanical energy received from input shaft 20 via face clutch 50 to epicyclic differential 58 as part of the first power path. In addition, carrier shaft 51 is connected to communicate mechanical energy to gear 54, defined by gear ratio 1/k_v, which communicates mechanical power to variable displacement piston pump 62 as part of the second power path. In the embodiment shown in FIG. 3, gear 54 also communicates mechanical power to accessory pumps 66. Mechanical power provided to variable displacement piston pump 62 causes the piston to move at the speed/frequency defined by gear 54. However, the volume of fluid pumped by variable displacement unit 62 per revolution depends on the position of swash plate 64 (also referred to as a ‘wobbler plate’). That is, the volume of fluid pumped can be increased or decreased by selectively adjusting the position of swash plate 64. In one embodiment, actuator 28 (shown in FIG. 1) is configured to modify the position of swash plate 64 based on the control signal provided by controller 24 (also shown in FIG. 1). In this way, the output flow associated with variable displacement unit 62 is selectively controlled to increase or decrease the volume of fluid pumped by variable displacement unit 62.

Fixed displacement unit 60 is hydraulically coupled to variable displacement unit 62. The volume of fluid provided by variable displacement unit 62 is provided to fixed displacement unit 60, which converts the received hydraulic power provided by variable displacement piston pump 62 to mechanical energy that is communicated via gear ring 56 defined by gear ratio 1/k_f. In addition, gear ring 56 is connected to supply mechanical power to accessory pumps 68. By adjusting the position of swash plate 64, the volume of fluid pumped by variable displacement unit 62 is varied, and as a result the mechanical energy generated by fixed displacement unit 60 is selectively controlled. In this way, the second power path provides a variable gear ratio that allows the speed of gear 56 to be selectively increased or decreased.

In the embodiment shown in FIG. 3, epicyclic differential 58 is employed to add (or subtract) power provided by the second power path (including the fixed and variable displacement units 60 and 62) with power provided by the first power path (communicated via carrier shaft 51). Epicyclic differential 58 includes a ring gear, planetary gears, and sun gear, wherein the first power path is connected to planetary gears, the second power path is connected to the ring gear, and the sun gear is connected to output shaft 22. Power supplied to the ring gear is added or subtracted (depending the operation of the variable displacement pump) to power supplied to the planetary gears, with the summed output provided via the sun gear to output shaft 22. In other embodiments, other well-known differentials may be employed to combine power provided via the first power path and the second power path, such as a sun-less differential.

In the embodiment shown in FIG. 3, permanent magnet generator (PMG) 70 is mechanically coupled to output shaft 22, and converts mechanical energy provided by output shaft 22 to electrical energy that is supplied to controller 24. In addition, the frequency of the power supplied by PMG 70 is used by controller 24 to monitor the speed of output shaft 22. In this way, PMG 70 operates both as a power source for controller 24 and as the speed sensor for monitoring the speed of output shaft 22.

In this way, AVSD 12 provides a controlled mechanical output that can be used to selectively vary the speed of attached loads without requiring conversion of mechanical power to pneumatic and/or electric power. A benefit of this arrangement is a reduction in weight and cost associated with typical power conversion systems (e.g., generators for conversion from mechanical to electric conversion, pneumatic motors for conversion from mechanical to pneumatic power).

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. An advanced variable speed drive (AVSD) comprising:
an input shaft rotabably coupled to receive mechanical power from an engine;
an output shaft mechanically coupled to provide mechanical power to an output;
a first power path having a fixed gear ratio mechanically coupled to receive power from the input shaft;
a second power path having a variable gear ratio mechanically coupled to receive power from the input shaft;
a differential mechanically coupled to the first power path, the second path, and the output shaft, wherein the differential combines power from the first and second power paths for provision to the output shaft; and
a controller that receives a speed command, monitors speed of the output shaft and selectively controls the variable gear ratio of the second power path to regulate the speed of the output shaft.

2. The AVSD of claim 1, wherein the first power path includes a carrier shaft connecting the input shaft to the differential.

3. The AVSD of claim 2, wherein the second power path includes:
a first gear connected to the carrier shaft;
a variable displacement unit mechanically coupled to the first gear that converts mechanical power provided by the first gear to hydraulic power;
a swash plate connected to the variable displacement unit having a position controllable by the controller to modify a volume of fluid provided by the variable displacement unit per each revolution of the first gear;
a fixed displacement unit hydraulically coupled to the variable displacement unit that converts hydraulic power to mechanical power; and
a second gear mechanically coupled to the fixed displacement piston pump for communicating power from the second power path to the differential.

4. The AVSD of claim 1, further including:
a permanent magnet generator mechanically coupled to the output shaft to convert mechanical power to electrical power that is supplied to the controller.

5. The AVSD of claim 4, wherein the controller monitors the speed of the output shaft by monitoring a frequency of the electrical power provided by the permanent magnet generator.

6. The AVSD of claim 1, wherein the differential is an epicyclic differential that includes a ring gear, one or more planetary gears, and a sun gear, wherein the first power path is mechanically coupled to the one or more planetary gears, the second power path is mechanically coupled to the ring gear, and the output shaft is mechanically coupled to the sun gear.

7. A system comprising:
an advance variable speed drive (AVSD) having an input shaft connected to receive a mechanical input and an output shaft connected to provide a mechanical output, wherein the AVSD includes a first power path having a fixed gear ratio, a second power path having a variable gear ratio, and a differential coupled to combine power received from the first power path and the second power path for provision to the output shaft;
a compressor connected to receive mechanical power from the output shaft;
a speed sensor connected to monitor speed of the output shaft; and
a controller connected to receive a speed command and a speed feedback signal from the speed sensor, wherein the controller modifies the variable gear ratio of the second power path based on a comparison between the speed command and the speed feedback signal to control the speed of the output shaft.

8. The AVSD of claim 7, wherein the first power path includes a carrier shaft connecting the input shaft to the differential.

9. The AVSD of claim 7, wherein the second power path includes:
a first gear connected to the carrier shaft;
a variable displacement unit mechanically coupled to the first gear that converts mechanical power provided by the first gear to hydraulic power;
a swash plate connected to the variable displacement unit having a position controllable by the controller to modify a volume of fluid provided by the variable displacement unit per each revolution of the first gear;
a fixed displacement unit hydraulically coupled to the variable displacement unit that converts hydraulic power to mechanical power; and
a second ring gear mechanically coupled to the fixed displacement piston pump for communicating power from the second power path to the differential.

10. The AVSD of claim 7, further including:
a permanent magnet generator (PMG) mechanically coupled to the output shaft to convert mechanical power to electrical power that is supplied to the controller.

11. The AVSD of claim 10, wherein the speed sensor is implemented by the PMG, which provides electrical power having a frequency related to the speed of the output shaft that is monitored by the controller.

12. The AVSD of claim 7, wherein the differential is an epicyclic differential that includes a ring gear, one or more planetary gears, and a sun gear, wherein the first power path is mechanically coupled to the one or more planetary gears, the second power path is mechanically coupled to the ring gear, and the output shaft is mechanically coupled to the sun gear.

13. A method of converting a variable speed mechanical input to a regulated, variable speed mechanical output rotating at a desired speed, the method comprising:
receiving a mechanical input via an input shaft;
communicating the mechanical input received via the input shaft to a first power path having a fixed gear ratio and a second power path having a variable gear ratio;
combining mechanical power received from the first power path with mechanical power received from the second power path via a differential for provision to an output shaft;
monitoring a speed of the output shaft; and
modifying the variable gear ratio of the second power path based on the monitored speed of the output shaft to regulate the speed of the output shaft to the desired speed.

14. The method of claim 13, wherein modifying the variable gear ratio of the second power path includes modifying a position of a swash plate associated with a variable displacement unit to selectively increase or decrease mechanical power provided by the second power path.

15. The method of claim 13, further comprising connecting the input shaft to the differential with a carrier shaft.

16. The method of claim 13, further comprising mechanically coupling a permanent magnet generator to the output shaft for converting mechanical power to electrical power, the electrical power being supplied to the controller.

17. The method of claim 16, wherein the monitoring of the speed of the output shaft further comprises monitoring a frequency of the electrical power provided by the permanent magnet generator.

18. The method of claim 13, further comprising mechanically coupling the first power path to one or more planetary gears, mechanically coupling the second power path to a ring gear, and mechanically coupling the output shaft to a sun gear.
